(19) United States
(12) Patent Application Publication
(10) Pub. No.: US 2007/0223818 A1
(43) Pub. Date: Sep. 27, 2007

(54) Method and apparatus for predicting the accuracy of virtual Scene based on incomplete information in video

(75) Inventors: Karel Marik, Revnice (CZ); Jiri Rojicek, Prague (CZ)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/390,038

(22) Filed: Mar. 27, 2006

(51) Int. Cl. G06K 9/68; G06K 9/00; G06K 9/62

(52) U.S. Cl. 382/218; 382/224

(57) ABSTRACT

When modeling an object in a visual input image, a model likelihood function for generating a predicted model based on the input data is moderated as a function of the portion of the object so as to less penalize regions of the model that tend to be more noisy. For instance, background subtraction algorithms often do not accurately interpret shadows of objects because the characteristics of shadows depend on so many factors, such as cloudiness, angle of the sun's rays, topography of the background upon which the shadow is cast, etc. Accordingly, the model likelihood function applied to a predicted shadow region of the model will be moderated so as to less penalize differences between the model and the input image with respect to shadows then with respect to other more reliably predictable portions of the image. A model likelihood function additionally or alternately may be moderated as a function of the object classification in situations where it is known that certain object classifications are more reliable than others.

### FIELD OF THE INVENTION

The invention pertains to techniques for generating a model of a scene based on pixel information in an input video stream. More particularly, the invention pertains to predicting the likelihood that a particular model accurately reflects events recorded in a video stream.

### BACKGROUND OF THE INVENTION

Due to advances in video processing technology as well as the general increase in processing power available for a given cost and size, software is now available that is intended to examine live or recorded video and automatically recognize physical features in the video and determine the nature of objects appearing in the video, e.g., a car, an animal, a building, a human, etc.

One well-publicized use of such technology is for automated recognition of individuals in video surveillance cameras by facial or other features. Another application of this technology is automatic target acquisition and surveillance in military operations.

The latest generations of automated video surveillance software has extended the technology to more than simply recognize physical features (e.g., the camera has captured two people on a street), but also to interpret temporal qualities associated with those physical features (i.e., from frame to frame of the video) to recognize patterns of behaviors, events, and activities as well, e.g., the two people are walking Southbound down the street or the two people are placing a large object in the back of a truck.

This technology, for instance, could be useful for automatically recognizing known terrorists or detecting abnormal or unusual activities and behaviors of persons, vehicles, and other objects of interest in airports and other public venues.

Techniques are now in use for analyzing a video input stream (a plurality of frames of video information) and generating a two-dimensional or a three-dimensional model that describes events that are occurring in the scene. In event prediction software, commonly although not necessarily, only objects in the foreground are of interest. In accordance with some known event prediction techniques for video streams, a frame of a video input stream is first analyzed pixel by pixel to determine what pixels correspond to background objects and what pixels correspond to foreground objects in the image. This is known as background subtraction. There are multiple known techniques for performing background subtraction. Some techniques are based on frame to frame comparisons to determine what pixels correspond to moving objects (with motion usually indicating a foreground object or at least an object that would be relevant to an “event” occurring in the scene). Other techniques compare the image to a known background reference image and only the pixels that do not match in value to the corresponding pixel in the reference image are deemed to be foreground pixels.

In most techniques used for background subtraction, such background subtraction renders an image in which each pixel is classified as either a background pixel or a foreground pixel. However, some techniques provide more than two possible values, with the value corresponding to the likelihood that the pixel is a background pixel or foreground pixel.

FIG. 1 is a frame 1 from an input video stream observed by a stationary camera of a scene in which two people are walking across a laboratory. FIG. 2 is a background-subtracted image 2 corresponding to the video image frame 1. FIG. 2 shows a simple background-subtracted image in which there are only two possible values for a pixel, i.e., background or foreground. As can be seen, the black pixels correspond to the background and the white pixels correspond to the foreground. It should be apparent from FIGS. 1 and 2 that the particular background subtraction technique used in this instance has, in general, correctly identified the background pixels and the foreground pixels. However, as should also be apparent, the technique is far from perfect. For instance, at least with respect to the person on the left, in large part, his legs have been improperly identified as background pixels.

In any event, after the background-subtracted image has been generated, the next step often is to predict the classification of the object(s), e.g., person, animal, car, tree, etc., in the image. Techniques for classifying an object in a video sequence rely on information that can readily be gathered from the image or sequence of images (e.g., a sequence of frames of a digital video) such as color, color continuity, size (e.g., number of pixels), motion, direction of motion, speed of motion, shape, etc.

After the objects have been classified, techniques and algorithms are used to study one or a plurality of consecutive frames of the background-subtracted images in order to predict what events are occurring in the images and generate a digital model of the scene (e.g., classes of objects in the scene, positions of the objects, the proportions of the objects, etc.). Although certainly not required, a virtual image or set of images based on the model may be generated to help individuals visualize the model. Again, many such scene modeling techniques are known. In such techniques, there may be thousands of potential virtual models that the algorithm starts with as potential candidates, but then, based on the algorithm, whittles that down to a single or a small number of most likely models. Merely as one example, a particle filtering algorithm (Sequential Monte Carlo method) can be used to replicate the scene models into a next generation, with each scene model having a probability value indicating the likelihood that the scene model matches the actual scene.

In the process of whittling down the multiple potential models to the one that is most likely an accurate representation of the events occurring in the original video input stream, algorithms are used to estimate how accurate any particular potential model may be. There are any number of different types of algorithms known in the prior art. In one technique, each pixel in the background-subtracted image is compared with each pixel in the corresponding frame of each of the potential corresponding virtual scenes. In other techniques, the edges or colors of objects can be compared. Yet other techniques may employ combinations of the aforementioned techniques. Even further, it is possible to compare pixels, edges and/or colors of only the modeled objects rather than the entire scene.

Merely as one simple example, if a given pixel in the background-subtracted image that is designated as a background pixel is also designated as a background pixel in the corresponding virtual scene image, it is assigned a penalty of zero. Likewise, if a given pixel in the background-subtracted image that is designated as a foreground pixel is also designated as a foreground pixel in the corresponding virtual scene image, it is assigned a penalty of zero. On the other hand, if a given pixel in the background-subtracted image is designated as a background pixel, but the corresponding pixel in the particular virtual scene image is designated as a foreground pixel, a penalty is assigned to that pixel. Likewise, if a given pixel in the background-subtracted image is designated as a foreground pixel, but the corresponding pixel in the particular virtual scene image is designated as a background pixel, a penalty is assigned to that pixel.

An overall model likelihood value is thereafter assigned to each of the potential virtual scene images. This model likelihood value may be a relatively simple function of the sum of all of the penalty values assigned to the pixels. Alternately, it model likelihood function may be a rather complex algorithm.

In one simple example, after the model likelihood values assigned to all of the potential virtual scene images corresponding to a given background-subtracted-image are calculated, the model with the highest model likelihood value is taken as representing the events occurring in the original video image.

It is desired to improve the accuracy of these techniques for predicting the events occurring in video image streams.

Accordingly, it is an object of the present invention to provide an improved method and technique for predicting the events occurring in a video image.

It is another object of the present invention to provide a technique for robust computation of model likelihood in the presence of uncertainty in an input video signal (e.g., noise, unreliability).

### SUMMARY OF THE INVENTION

In accordance with the principles of the invention, when modeling an object in a visual input image, a model likelihood function for selecting a predicted model that most accurately represents the actual scene based on the input data is moderated as a function of the portion of the object so as to less penalize regions of the model that tend to be more noisy. For instance, background subtraction algorithms often do not accurately interpret shadows of objects because the characteristics of shadows depend on so many factors, such as cloudiness, angle of the sun's rays, topography of the background upon which the shadow is cast, etc. Legs are more difficult to correctly identify than head and shoulders. Accordingly, the model likelihood function applied to a predicted shadow region or leg region of the model will be moderated so as to discount differences between the model and the input image with respect to such noisy regions relative to other, more reliably predictable (less noisy) regions of the image. A model likelihood function additionally or alternately may be moderated as a function of the object classification in situations where it is known that certain object classifications are more reliable than others.

### BRIEF DESCRIPTION OF THE DRAWINGS

FIG. 1 is a diagram illustrating a frame of a video input stream obtained from a surveillance camera.

FIG. 2 is a diagram illustrating a background-subtracted image corresponding to the image of FIG. 1.

FIG. 3 is a block diagram illustrating a processor within which the present invention may be implemented.

FIG. 4 is an image from a virtual scene generated as a prediction of the events occurring in the input video stream from which FIGS. 1 and 2 are taken and corresponding to the same frame as FIGS. 1 and 2.

### DETAILED DESCRIPTION OF THE INVENTION

The present invention is a method and apparatus for processing image data in order to predict events occurring within an input video image and generating models (or virtual scenes) depicting those events. The key aspects of the present invention focus on the technique for generating model likelihood values for determining which of a plurality of potential models (or virtual scenes) is most likely accurate. The invention can be implemented through software loaded on a computing device, such as a microprocessor, processor, or PC. It can be embodied within a video surveillance system or separately connected to a video surveillance system. Alternately, the invention can be implemented by any other reasonable means, including an application specific integrated circuit (ASIC), digital hardware, firmware, or any combination of the aforementioned.

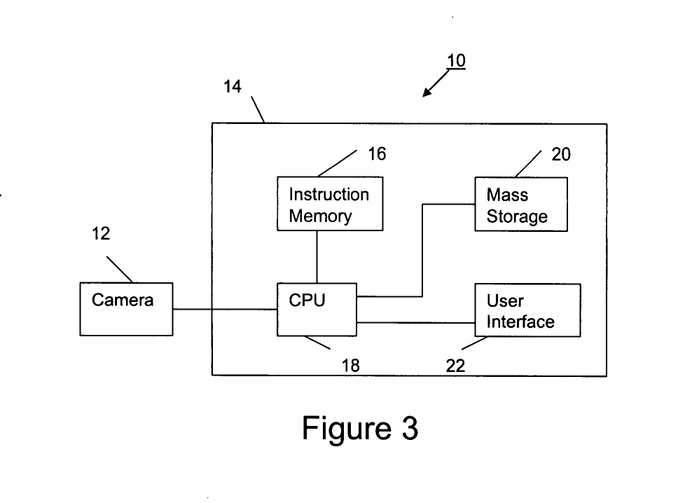

FIG. 3 is a block diagram showing the major components of a video surveillance system 10 within which the present invention is incorporated. The system comprises one or more cameras 12 that output digital images of one or more surveillance areas. The camera 12 sends a video feed to a processing system 108. Processing system 14 includes an instruction memory 16 for storing and providing software instructions to a central processing unit 18 for execution. The central processing unit 18 operates on the digital data stream from the camera 12 in accordance with these instructions so as to analyze the incoming images to produce useful results. The processor 18 further includes a mass storage device 20, such as a hard disk, for storing the video images and/or the output information. In addition, there is a user interface 22 so that an operator may interact with the system. For instance the user interface typically may comprise any one or more of a computer monitor, keyboard, and/or computer mouse device.

In a preferred embodiment, the invention is implemented in software. However, this is not a limitation of the invention and the invention can be implemented in any reasonable fashion, including firmware, hardware, software, or combinations of any or all of the above.

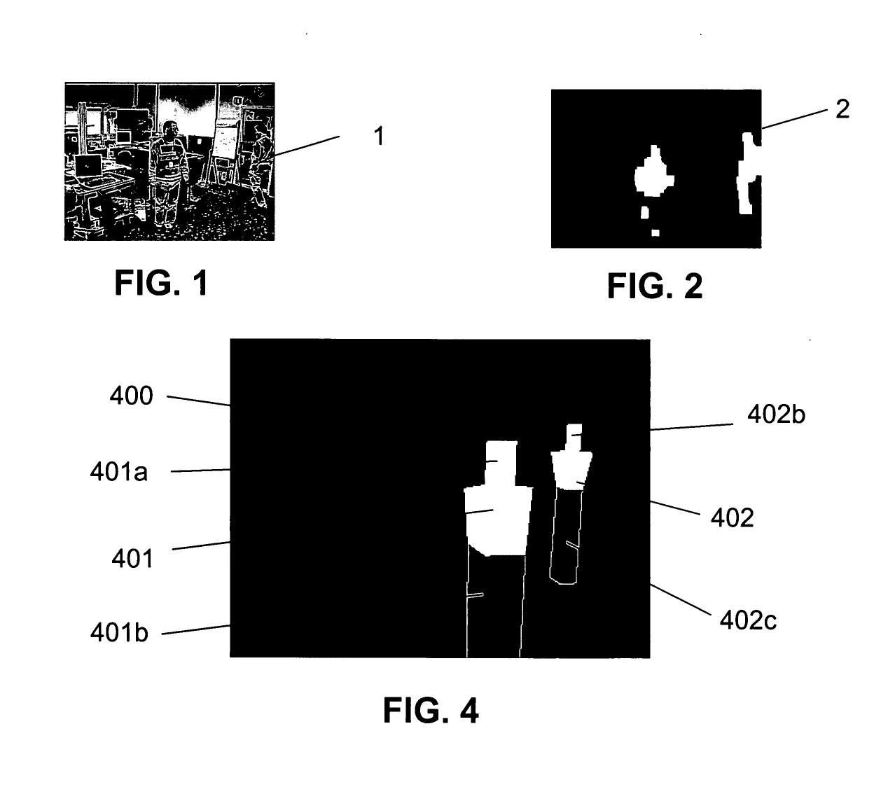

One or more frames from a video camera is input to the system 14. With reference to FIG. 1, we will concentrate on a single frame 1 (or image) for exemplary purposes and exposition in connection with the present invention. Image 1 includes a plurality of pixels, each pixel typically represented by a color value for each of three primary colors. In one exemplary embodiment of the invention, the system performs a background subtraction on the image using any of the known background subtraction techniques to generate a background-subtracted image, such as shown in FIG. 2. In the background-subtracted image 2 of FIG. 2, all of the pixels in the image have been classified as either background pixels or foreground pixels. White represents foreground pixels and black represents background pixels.

Background subtraction to generate a background-subtracted image is not a requirement of the present invention, but is a technique commonly used in the process of generating event models of video input streams. The invention can be applied to other kinds of video signal or other kinds of transformations of video signals other than background-subtracted transformations, such as edge filter images or even full color video (e.g. color matching for different parts of an object model). It also may be applied, not only to multiple-hypothesis scene understanding systems, but to any situation in which one wishes to determine the likelihood that one or more models interpret an observed scene correctly.

Event prediction algorithms usually base the predictions only on the foreground pixels. Particularly, the background portion of an image typically is stationary and offers essentially no information as to the events occurring in the images. (Of course, the background scene may provide contextual information useful in determining the events, such as, if it is known that camera 12 is a surveillance camera in a chemical laboratory, then it is known that it is very unlikely that the objects in the image are cars or animals and this can be factored into the event prediction algorithms.) Again, however, this is not a limitation of the invention, which can be used to evaluate an entire image or any portion thereof as well as different types of images (e.g., background-subtracted images, color images, gray-scale images, etc.).

Commonly, an event prediction algorithm starts with a plurality of potential models that might represent the events occurring in the images. It would not be uncommon to start with thousands of potential models of a scene. Techniques for generating two or three dimensional models of scenes are known. In either case, for each potential model, the algorithm generates a model image 400 such a depicted in FIG. 4. If the models being generated are two dimensional, then the model images are two dimensional. However, if the models are three dimensional, then the images are two dimensional representations of the three-dimensional models. FIG. 4 is the predicted virtual scene image 400 corresponding to one of the plurality of potential models. As can be seen, in this image, there are two foreground objects 401 and 402 and they are both predicted to be persons. In each object, the upper portion 401a, 402a is the head and shoulders of the predicted person while the lower portions 401b and 402b are the lower torso and legs of the predicted person.

In choosing the best model from a plurality of potential models, a model likelihood function is applied to calculate the extent to which each potential virtual scene image depicting a model matches the input image to which it corresponds (or the background-subtracted or other transformation/version thereof, as previously noted). In one possible embodiment, each pixel in the model's virtual scene image is compared to the corresponding pixel in the background-subtracted image and a penalty value is assigned to each pixel in the virtual scene image, that value depending on whether the two corresponding pixels match each other. It should be understood that there are different techniques for matching the input image to a model, of which pixel level comparison is merely one example. The majority of matching techniques operate with just the pixels “belonging” to an identified object or to its neighborhood. Alternately, many approaches even do not even involve a pixel level comparison. Rather, they just compute some aggregated statistics or features from these pixels and compare these aggregates. In such techniques, it is often not even necessary to render a virtual scene in order to compare it with the input image. What is significant, however, is that, in all such approaches, the different parts of identified object can be weighted differently based on known relative reliability statistics or data as to those different parts.

In a simple exemplary model likelihood function (sometimes called a matching function), if the two corresponding pixels are both marked as background pixels (i.e., pixels that correspond to the background portion of the image) or are both marked as foreground pixels (i.e., pixels that correspond to the foreground portion of the image), a penalty of zero assigned to that pixel. If, however, in the virtual scene image, a pixel is indicated as a foreground pixel, but the corresponding pixel in the background-subtracted image is indicated as a background pixel or a pixel in the virtual scene image is indicated as a background pixel, and the corresponding pixel in the background-subtracted image is indicated as a foreground pixel, then a penalty value is assigned to that pixel, e.g., a value of 1. After all the pixels have been compared, a model likelihood function is applied, which may be some function of the penalties, to generate an overall model likelihood value for that potential virtual scene image. This is repeated for every potential model. The model having the highest model likelihood value is selected.

In accordance with the principles of the present invention, the model likelihood function is moderated based on predetermined information as to the likely reliability of accurately identifying a pixel as being a background pixel or a foreground pixel. For instance, it is well-known that, within a certain object class, e.g., person object, certain regions of the object are more difficult to detect, i.e., more noisy, than other regions. For instance, it is well known that, with respect to person class objects, correctly identifying pixels corresponding to the person's legs is much more difficult than identifying pixels corresponding to the person's head and shoulders. Hence, pixels comprising the object that correspond to the person's legs are less likely to be correctly identified than pixels comprising the object that correspond to the person's head or shoulders legs. As another example, in background subtraction algorithms, shadows of objects are often very difficult to detect reliably because the characteristics of shadows depend on so many factors, such as cloudiness, angle of the sun's rays, topography of the background upon which the shadow is cast, etc.

In accordance with the principles of the present invention, the model likelihood function assigns different penalty values to different pixels in an image, the value being a function of a predetermined reliability of the prediction based on the class of object and/or the region of the object.

Furthermore, object classification reliability also might differ depending on the object classification. Different object classification techniques and algorithms may have different reliability parameters. However, to the extent that, for a given object classification technique, it is known that certain objects tend to be more reliably identified than others, the objects identified as belonging to a more reliably identified object class can be weighed more heavily during matching than objects identified as being of a less reliably identified object class.

Thus, referring to FIG. 4, for example, it illustrates a simple embodiment of the invention in which the model likelihood function is moderated as a function of the region of the object, For instance, one penalty function is applied to the pixels in the virtual scene image that correspond to the head and shoulders of the model persons and a different penalty function is applied to the pixels corresponding to the lower torso and legs of the model person objects. This is graphically illustrated in FIG. 4 by using the color white to indicate high reliability pixels for which a first penalty function will be applied and gray to indicate lower reliability pixels for which a second penalty function will be applied (and black to indicate background pixels). Of course, there can be more than two penalty functions. For instance, there may be a first penalty function for the head and shoulders, a second penalty function for the torso, and a third penalty function for the legs.

In one embodiment of the invention, entirely different penalty functions are used for the different objects and/or regions of objects. However, in other embodiments of the invention, the same basic penalty function can be used for all of the regions, with the penalties assessed to pixels within different regions simply being multiplied by a different weighting factor, the weighting factor being proportional to a predetermined reliability rating. In one simple embodiment, and with reference to FIG. 3, (1) a penalty value of 1 can be applied when the corresponding pixel in the virtual scene image (i.e., model) and the background-subtracted image are black/white or white/black, respectively, (2) a penalty value of 0 can be assigned to corresponding pixels that are white/white or black/black, respectively, and (3) a penalty value of 0.5 (or any other fraction) can be applied if the corresponding pixels in the two images are gray/black. The afore-described penalty function can be written mathematically as follows:

$$Penalty = {\sum }_{all image \\ pixels , p} diff ( {p}_{scene} , {p}_{model} )$$

where
diff=0, if B_{model}/B_{scene}, W_{model}/W_{scene}, or G_{model}/W_{scene},
diff=1, if B_{model}/W_{scene} or W_{model}/B_{scene},
diff=0.5, if G_{model}/B_{scene},
B_{scene}=black=background in background-subtracted image,
W_{scene}=white=foreground in background-subtracted image,
B_{model}=black=background in model image,
W_{model}=white=foreground in model image with high reliability, and
G_{model}=gray=foreground in model image with low reliability.

The overall model likelihood function is a function of the sum of penalties represented by the above equation, it is not the sum itself. In other words:

Model Likelihood Function=f(Penalty)

Merely as an example, Juza, M., Marik, K, Rojicek, J. and Stiuka, P., 3D Template-Based Single Camera Multiple Object Tracking Computer Vision. Winter Workshop 2006, Ond\check{}rej Chum, Vojt\check{}ech Franc (eds.) Tel\check{}c, Czech Republic, Feb. 6-8, 2006 Czech Pattern Recognition Society, incorporated herein by reference, discloses in equation (6) thereof an exemplary model likelihood function, ωᵢ, that can be used in connection with the present invention. Note that the model likelihood function is termed “particle weight” in this publication.

Using the principles of the present invention, more accurate selection between a plurality of potential models (or virtual scene images) is achieved.

While the invention has been described above in connection with one or more specific embodiments in which background subtraction is used and the model images are compared to the corresponding background-subtracted images, this is merely exemplary. The fact that the invention has been described in connection with an embodiment in which the input image is first analyzed to identify distinct objects in the image also is merely exemplary. The invention can be applied in other situations also. More broadly, the invention can be applied to determine the likely accuracy of a predicted model of a scene based on an input image of said scene by generating at least one potential model of the scene depicting events occurring in the scene and determining a likely accuracy of that potential model by comparing the pixels of the generated model scene to the pixels of the input image and applying a model likelihood function to differences between the pixels, wherein the model likelihood function differs as a function of a characteristic of the model. In the example given above, the penalty function within the model likelihood function is moderated. More specifically, in the example, the penalty assigned to each pixel is weighted as a function of whether the pixel corresponds to a more noisy region of the object (e.g., legs) or a less noisy region of the object (head and shoulders).

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A method of calculating an accuracy of a predicted model of a scene that is based on an input image of said scene, said method comprising the steps of:
(1) obtaining an input image depicting a scene, said image comprising a first plurality of pixels;
(2) generating at least one potential model of said scene depicting events occurring in said scene, wherein said model comprises a second plurality of pixels corresponding to said first plurality of pixels; and
(3) determining an accuracy of said potential model by comparing at least some of said second plurality of pixels to corresponding ones of said first plurality of pixels and assigning a value to differences between each said compared pair of pixels, wherein said value is a function of a characteristic of said model that differs as a function of a portion of said model.

2. The method of claim 1 further comprising the step of:
(4) detecting and classifying at least one predicted object in said input image; and
wherein said characteristic is a predetermined reliability of said model as a function of a classification of said predicted object.

3. The method of claim 1 further comprising the step of:
(4) detecting and classifying at least one predicted object in said input image; and
wherein said characteristic is a predetermined function of a reliability of said model as a function of a region of said predicted object; and wherein said at least some of said second plurality of pixels comprises said pixels comprising said at least one object.

4. The method of claim 3 wherein, in step (3), a higher value is assigned to differences between pixel pairs corresponding to regions of the model that tend to be more noisy than to the same differences between pixel pairs corresponding to regions of the model that tend to be less noisy.

5. The method of claim 1 further comprising the step of:
(4) performing background subtraction on said input image to classify pixels in said image as either background pixels or foreground pixels.

6. The method of claim 5 wherein step (2) comprises generating a plurality of potential models of said scene based on said foreground pixels, each said model comprising an image comprising at least one plurality of pixels; and
wherein step (3) comprises the steps of:
(3.1) comparing each of said potential models to said foreground pixels of said input image;
(3.2) assigning values to differences between said pixels of said model and corresponding foreground pixels of said input image to generate a model likelihood value for said potential model, wherein said assigned values are a function of predetermined data as to a reliability of different regions of said potential model; and
(3.3) selecting at least a one of said potential models based on said model likelihood values of said potential models.

7. The method of claim 6 wherein step (3.2) comprises applying a weighting factor to said differences, said weighting factor being a function of said corresponding region.

8. The method of claim 6 wherein said model is based on a plurality of said input images.

9. A method of generating a predicted model of a scene based on an input image of said scene, said method comprising the steps of:
(1) obtaining an input image of a scene comprising a first plurality of pixels;
(2) classifying at least one predicted object in said image;
(3) generating a plurality of potential models of said scene depicting events occurring in said scene, each of said potential models comprising a second plurality of pixels;
(4) determining an accuracy of said potential model by comparing at least some of said second plurality of pixels to corresponding ones of said first plurality of pixels and assigning a value to differences between said compared pixels, wherein said value is a function of a characteristic of said model that differs as a function of a portion of said model; and
(5) selecting at least a one of said plurality of potential models based on said value.

10. The method of claim 9 wherein said at least some of said second plurality of pixels comprises said pixels comprising said at least one object.

11. The method of claim 10 wherein said characteristic is a region of a predicted object.

12. The method of claim 11 wherein said characteristic is a predetermined function of a reliability of said model as a function of a region of said predicted object.

13. The method of claim 12 wherein, in step (4), a higher value is assigned to differences between pixel pairs corresponding to regions of the model that tend to be more noisy than to the same differences between pixel pairs corresponding to regions of the model that tend to be less noisy.

14. The method of claim 9 further comprising the step of:
(6) performing background subtraction on said input image to classify pixels in said image as either background pixels or foreground pixels; and
wherein step (4) comprises the steps of:
(4.1) comparing each of said potential models to said foreground pixels of said input image;
(4.2) assigning values to differences between said pixels of said model and corresponding pixels of said input image to generate a model likelihood value for said potential model, wherein said assigned values are a function of predetermined data as to a reliability of different regions of said potential model; and
(4.3) selecting at least a one of said potential models based on said model likelihood values of said potential models.

15. The method of claim 14 wherein step (4.2) comprises applying a weighting factor to said differences, said weighting factor being a function of said corresponding region.

16. The method of claim 14 wherein said model predicts events occurring in said input image.

17. A computer program product embodied on a computer readable medium for calculating an accuracy of a predicted model of a scene that is based on an input image of said scene, the product comprising:
first computer executable instructions for obtaining an input image depicting a scene, said image comprising a first plurality of pixels;
second computer executable instructions for generating at least one potential model of said scene depicting events occurring in said scene, wherein said model comprises a second plurality of pixels corresponding to said first plurality of pixels; and
third computer executable instructions for determining an accuracy of said potential model by comparing at least some of said second plurality of pixels to corresponding ones of said first plurality of pixels and assigning a value to differences between each said compared pair of pixels, wherein said value is a function of a characteristic of said model that differs as a function of a portion of said model.

18. The computer program product of claim 17 further comprising fourth computer executable instructions for detecting and classifying at least one predicted object in said input image; and
wherein said characteristic is a predetermined reliability of said model as a function a classification of said predicted object.

19. The computer program product of claim 17 further comprising fourth computer executable instructions for detecting and classifying at least one predicted object in said input image; and
wherein said characteristic is a predetermined function of a reliability of said model as a function of a region of said predicted object and wherein said at least some of said second plurality of pixels comprises said pixels comprising said at least one object.

20. The computer program product of claim 17 wherein said third computer executable instructions assign a higher value to differences between pixel pairs corresponding to regions of the model that tend to be more noisy than to the same differences between pixel pairs corresponding to regions of the model that tend to be less noisy.

21. The computer program product of claim 17 further comprising:
fifth computer executable instructions for performing background subtraction on said input image to classify pixels in said image as either background pixels or foreground pixels.

22. The computer program product of claim 21 wherein said second computer executable instructions comprises computer executable instructions for generating a plurality of potential models of said scene based on said foreground pixels, each said model comprising an image comprising a plurality of pixels; and
wherein said third computer executable instructions comprise:
computer executable instructions for comparing each of said potential models to said foreground pixels of said input image;
computer executable instructions assigning values to differences between said pixels of said model and corresponding foreground pixels of said input image to generate a model likelihood value for said potential model, wherein said assigned values are a function of predetermined data as to a reliability of different regions of said potential model; and
computer executable instructions for selecting at least a one of said potential models based on said model likelihood values of said potential models.

23. The computer program product of claim 22 wherein a different weighting factor is applied to said differences, said weighting factor being a function of said corresponding region.

24. A method calculating an accuracy of a predicted model of a scene that is based on an input image of said scene, said method comprising the steps of:
(1) obtaining an input image depicting a scene, said image comprising a first plurality of pixels;
(2) generating at least one potential model of said scene depicting events occurring in said scene, wherein said model comprises a second plurality of pixels corresponding to said first plurality of pixels; and
(3) determining an accuracy of said potential model by comparing at least some of said second plurality of pixels to at least some of said first plurality of pixels and assigning values to differences between said compared pixels, wherein said value is a function of a characteristic of said model that differs as a function of a portion of said model.

25. A method of calculating an accuracy of a predicted model of a scene that is based on an input image of said scene, said method comprising the steps of:
(1) obtaining an input image depicting a scene, said image comprising a first plurality of pixels;
(2) generating at least one potential model of said scene depicting events occurring in said scene, wherein said model comprises a second plurality of pixels corresponding to said first plurality of pixels; and
(3) determining an accuracy of said potential model by comparing a feature of said potential model, said feature based on data aggregated from at least some of said second plurality of pixels, to corresponding feature data of said input image and assigning a value to differences between said model and said input image, wherein said value is a function of a characteristic of said model that differs as a function of a portion of said model.

26. The method of claim 25 wherein said characteristic is a predetermined function of a reliability of said model as a function of a portion of said model.

27. The method of claim 26 further comprising the step of:
(4) detecting and classifying at least one predicted object in said input image; and
wherein said characteristic is a predetermined function of a reliability of said model as a function of a region of said predicted object.
